(19) United States
(12) Patent Application Publication
(10) Pub. No.: US 2013/0226675 A1
(43) Pub. Date: Aug. 29, 2013

(54) SYSTEM AND METHODS FOR CONTROLLING ADVERTISEMENTS AND USER POPULARITY WITHIN AN ONLINE COMPUTER SYSTEM SOCIAL MEDIA NETWORK

(71) Applicant: Rodrigo Senra, Orlando, FL (US)

(72) Inventor: Rodrigo Senra, Orlando, FL (US)

(21) Appl. No.: 13/404,382

(22) Filed: Feb. 24, 2012

(51) Int. Cl. G06Q 30/02

(52) U.S. Cl. 705/12

(57) ABSTRACT

System and methods for controlling advertisements and user popularity within an online social media network includes providing celebrity created content to non-celebrity members and embedding celebrity approved advertisements into the content. Upon determining that a member has voted to subscribe to the celebrity for a predetermined period of time, the celebrity popularity rating is increased, and upon determining that a user has clicked on an approved advertisement, the celebrity is compensated by the sponsor.

### TECHNICAL FIELD

The present invention relates generally to a system and method for establishing and maintaining communication between users of a web based database/social media system, and more particularly to a social media environment capable of generating real time popularity ratings and advertisement control for celebrity users.

### BACKGROUND

The statements in this section merely provide background information related to the present disclosure and may not constitute prior art.

Social media sites have changed the way people stay in touch. This is especially true for celebrities who utilize social media sites to communicate with fans in a safe, fun and timely manner. To this end, celebrities typically create a profile page on a conventional social media site, in the same manner as non-celebrity users, in order to post messages for their fans. Unfortunately, this has caused problems by unscrupulous individuals who create imposter pages claiming to be a celebrity.

As most social media sites do not charge fees to their users, it is common for these sites to sell advertising space in the form of web banners on the various pages. However, these banners are not controlled by the actual user/celebrity onto whose page they are displayed, and all proceeds from the advertisement typically go directly to the social media site. This can pose numerous problems for celebrities who may prefer that the social media site not advertise particular sponsors on their pages due to pre-existing sponsorship and/or contractual relationships with competing interests. Moreover, as the celebrities are not receiving a financial benefit in using the social media page, there is no incentive to be an active user of the site.

Another problem with existing social media sites revolves around stale ratings. Many social media sites rank the popularity of celebrities (and non-celebrity users) based on the number of other people who are “connected to” or “follow” the celebrities' social media page. However, as celebrities lose relevance over time, they continue to be “followed” by the users unless the user takes affirmative action to remove the association. This results in celebrities whose relevance has greatly diminished having a ranking higher than current, more relevant, celebrities.

Accordingly, it would be beneficial to provide a method and system for allowing celebrities and non-celebrity members to communicate in a social media setting that does not suffer from the drawbacks described above.

### SUMMARY OF THE INVENTION

The present invention is directed to a method for allowing a non-celebrity member to communicate with, and vote for a celebrity member within a social media web site. One embodiment of the present invention can include establishing communication between the non-celebrity member and an application system, generating a member page for the non-celebrity identifying celebrity members of the social media website, and generating a first celebrity member page having limited content, celebrity approved advertisements, and a vote button. The method can also include determining that the non-celebrity member has voted for the celebrity, updating the celebrity popularity rating, and generating a second celebrity member page having full celebrity content, celebrity approved advertisements, and a direct communication pathway between the celebrity member and the non-celebrity member.

Another embodiment of the present invention can be directed to a method for allowing a celebrity member to create and maintain a social media page having celebrity approved advertisements. The method can include validating an identity of the celebrity, generating a celebrity popularity rating and access page, providing a list of sponsorship opportunities, displaying the approved advertisements on the celebrity page, and compensating the celebrity for the selected advertisement.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a simplified block diagram of a system for controlling advertisements and user popularity within an online computer system social media network that is useful for understanding the inventive concepts disclosed herein.

FIG. 1a is a cutout block diagram of an application system for use with the system of FIG. 1, in accordance with one embodiment of the invention.

FIG. 2 is a block diagram of a database in accordance with one embodiment.

FIG. 3 is an exemplary display screen in accordance with one embodiment.

FIG. 4a is another exemplary display screen in accordance with one embodiment.

FIG. 4b is another exemplary display screen in accordance with one embodiment.

FIG. 5a is another exemplary display screen in accordance with one embodiment.

FIG. 5b is another exemplary display screen in accordance with one embodiment.

FIG. 5c is another exemplary display screen in accordance with one embodiment.

FIG. 6 is a flow chart illustrating a method for allowing a non-celebrity member to communicate with, and vote for their favorite celebrities in a social media setting, in accordance with one embodiment of the present invention.

FIG. 7 is a flow chart illustrating a method for allowing a celebrity member to communicate with non-celebrity members, and to receive compensation from sponsors who advertise on the celebrity page, in accordance with one embodiment of the present invention.

FIG. 8 is a flow chart illustrating a method for advertising on a celebrity page in accordance with one embodiment of the present invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As will be appreciated by one skilled in the art, aspects of the present invention may be embodied as a system, method or computer program product. Accordingly, aspects of the present invention may take the form of an entirely hardware embodiment, or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

As described throughout this document the term celebrity can include any person entity or object to which another individual would like to communicate with in a social network setting. As such, the term is not to be construed as limited to just actors, television personalities and the like. Additionally, the term system management can include individuals who maintain and/or operate the social media site and/or the various system components.

A method and system is provided for establishing a social media network wherein celebrity members and non-celebrity members can communicate in a fun, safe and timely manner. Celebrity members can be assigned a unique profile page where they can post content geared towards their fans. This celebrity page can further include a dedicated advertising area or “PoPAd” which can be controlled by the celebrities themselves. To this end, celebrity members can have the opportunity to sell this advertising area to sponsors and a portion of the revenue generated by the sponsors will go directly to the celebrity. The rate sponsors pay can be based on a fixed fee, or can be based upon the popularity of the celebrity based on the voting trends of non-celebrity members (i.e. popularity rating).

Non-celebrity members (also referred throughout this document as a “user”) of the social media site can also create a unique profile page where they can post content for other members to view. Non-celebrity members will be able to access their favorite celebrity members profiles in order to communicate in a social media setting by voting (i.e., subscribing) for their favorite celebrities. Each user can chose multiple celebrity members which can be stored in a list called PoPlairs. This vote will last a predetermined time after which, the user will need to re-vote to maintain contact with the celebrity on the social media site. As will be described below, each celebrity vote will be tracked in order to display a list of celebrities whose popularity is rising and falling. Moreover, the particular users who have subscribed to the celebrity can receive exclusive content not available anywhere else directly from said celebrity.

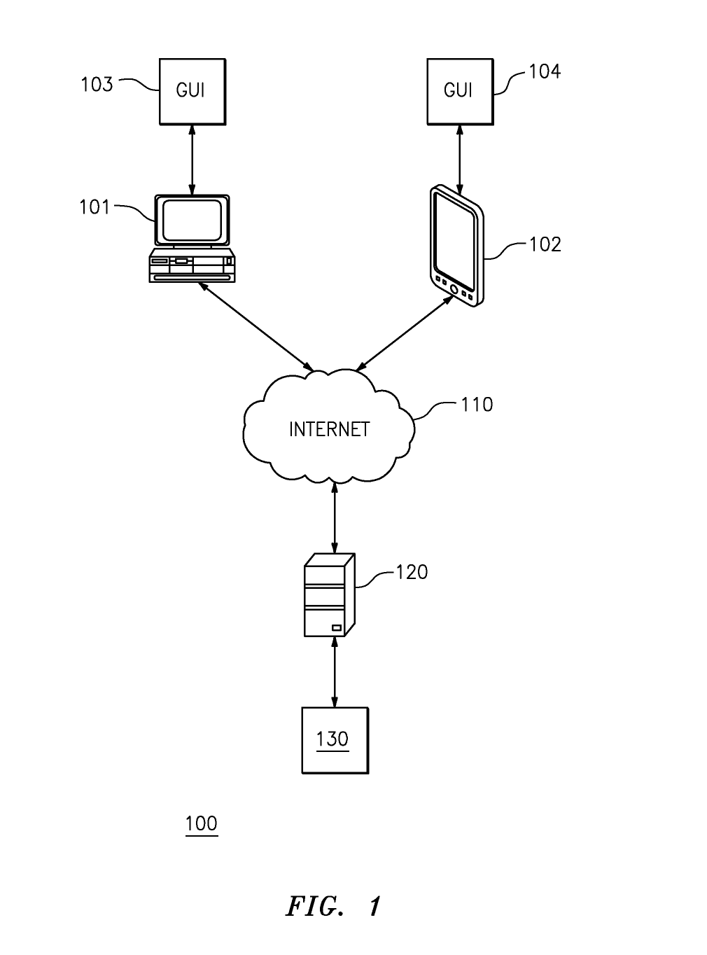

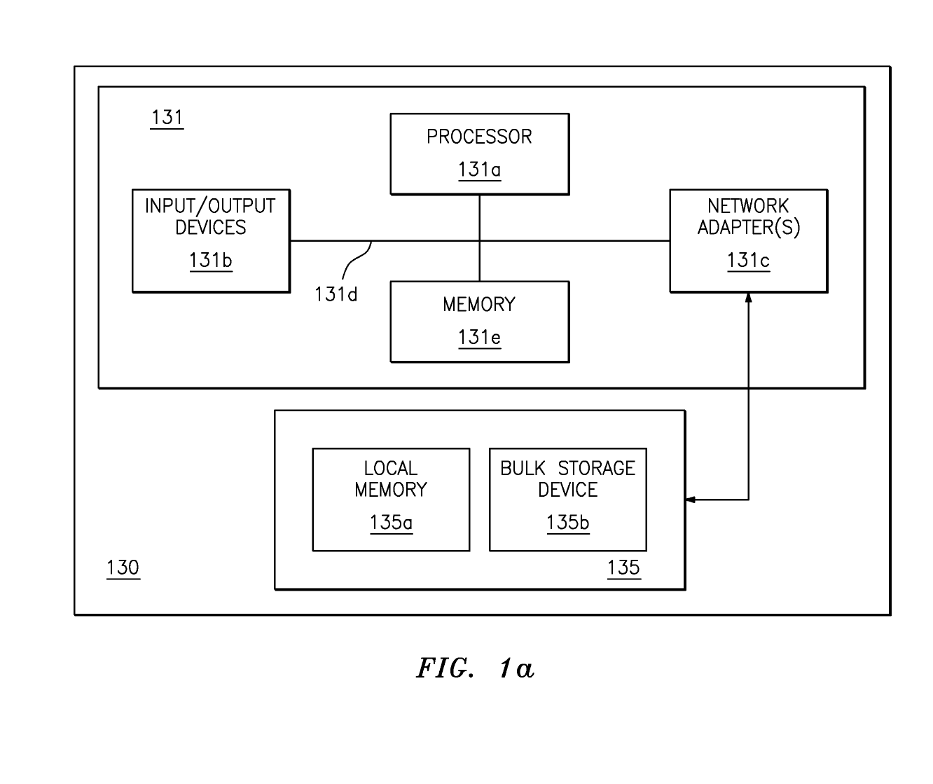

FIG. 1 illustrates a general architecture of a system that operates in accordance with one embodiment of the present invention. The system for controlling advertisements and user popularity within an online computer system social media network 100 can function to create an online computer based social media platform through which celebrities and non-celebrities can communicate in the manner described below.

As shown in FIG. 1, the system 100 can include a plurality of interface devices 101 and 102 connected to a database system 130 via an interface gatekeeper 120 and a network such as the internet 110. The user interfaces 101 and 102 will preferably comprise conventional computers, smart phones or tablet devices, but may also include any mechanism by which an external individual, processor or device can obtain and provide data, respectively, to or from the database system 130 of the present invention.

The interface devices 101 and 102 may be configured to display a graphic user interface (GUI) 103 and 104, respectively, that includes information pertaining to a social media website for celebrity and non-celebrity communication. The interface gatekeeper 120 may be a server or other such device for determining user access to the various portions of the database system 130.

As shown in cutout FIG. 1a, the database system 130, according to one embodiment, can include an application server 131 and a database 135. The application server 131 shall preferably be a server or other such device responsible for generating content as well as exchanging information with the interface devices 101 & 102 and the database 135. As shown, the server 131 can include at least one processor 131a coupled to memory elements 131e through a connection device such as a system bus 131d. The system 130 can store program code within memory elements 131e which can be accessed by the processor 131a via the system bus 131d. In one aspect, for example, server 131 can be implemented as a computer that is suitable for storing and/or executing program code. It should be appreciated, however, that server 131 can be implemented in the form of any system comprising a processor and memory (integrated or separate) that is capable of performing the functions described within this specification.

Memory elements 131e and database 135 can include one or more physical memory devices such as, for example, local memory 135a and one or more bulk storage devices 135b. Local memory 135a refers to random access memory or other non-persistent memory device(s) generally used during actual execution of the program code. Bulk storage device(s) 135b can be implemented as a hard drive or other persistent data storage device. Server 131 also can include one or more cache memories (not shown) that provide temporary storage of at least some program code in order to reduce the number of times program code must be retrieved from bulk storage device 135b during execution.

Input/output (I/O) devices 131b such as keyboards, display monitors, and pointing devices can be coupled to system 130. The I/O devices can be coupled to system 130 either directly or through intervening I/O controllers. Network adapters 131c can also be coupled to the system 130 in order to allow the system to connect to other devices such as the user interfaces 101 and 102. The network adapter can communicate via any number of known transport mechanisms such as the internet and/or private or public networks. Modems, cable modems, and Ethernet cards are examples of different types of network adapters that can be used with system 130.

Although described above as utilizing a separate interface gatekeeper 120, application server 131 and database 135, one of skill in the art will recognize that these need not be separate components. Moreover, it is noted that the above description of the server 130 can also describe the functioning components for one or more of the gatekeeper 120 and/or the system interfaces 101 and 102.

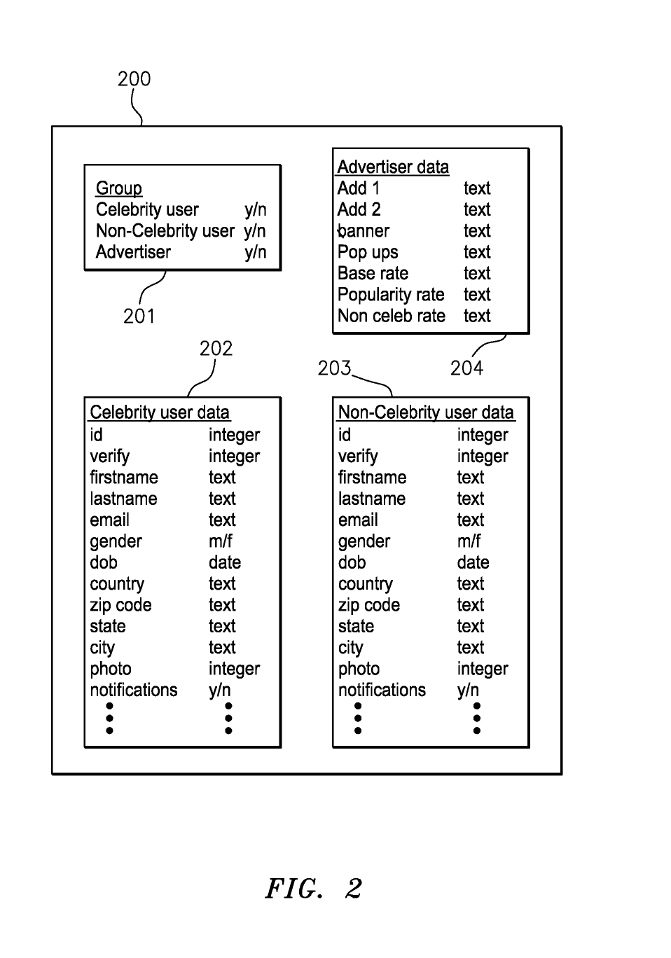

FIG. 2 illustrates a block diagram of data 200 that may be stored within database 135. According to this non-limiting embodiment, registered users of the social media site may be subdivided into groups 201 based upon predetermined criteria. For example, registered users may be placed into groups and classified as celebrity users, non-celebrity users and/or advertisers. In one embodiment, a celebrity can include an actor or other person wishing to provide content to a fan base. Non-celebrity users can include members of the general public who are fans of a the celebrity, or individuals who wish to learn more about the celebrity. Finally, advertisers can include companies or individuals who wish to display paid advertisements such as banners or adds on a celebrity page. Additional information that can be stored includes, for example: Celebrity user data 202, Non-Celebrity user data 203, and advertiser data 204.

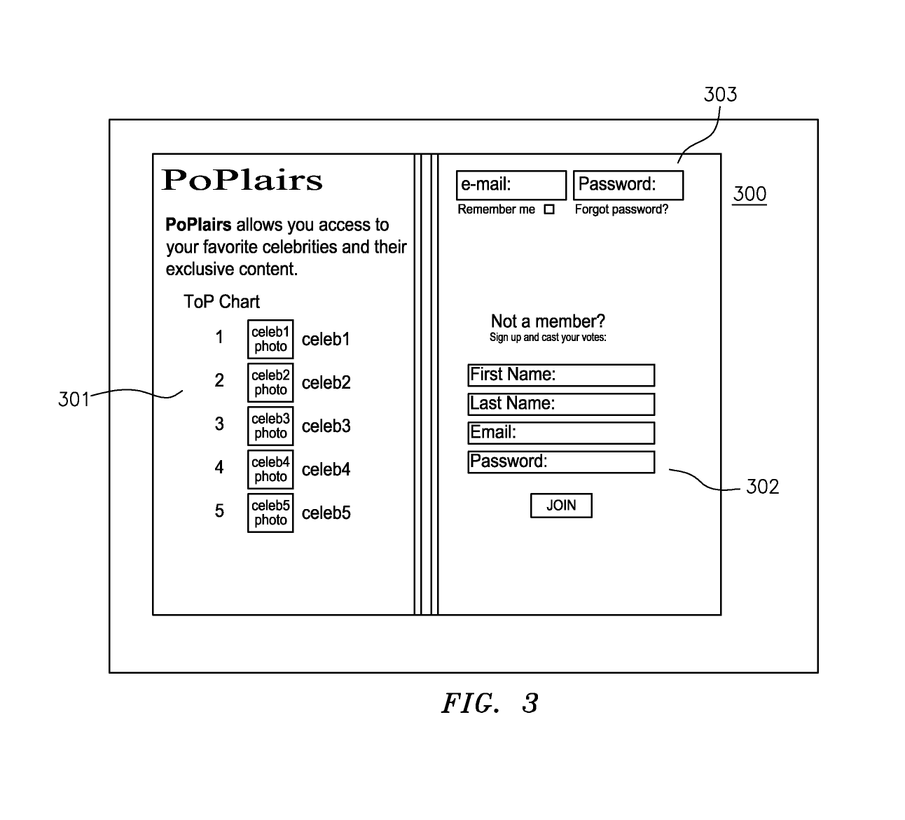

FIG. 3 illustrates an exemplary presentation screen generated by the application system 130 to be displayed as a GUI 103 or 104 of an interface device 101 or 102. In this example, an opening page 300 is generated in response to a user navigating to the website URL. This opening screen 300 can include a brief synopsis of information contained in the site. For example, the screen may list basic information pertaining to the most popular celebrity members 301 based on non-celebrity voting. Additionally, the screen may provide options for registering new users 302, or for allowing previously registered members to log in 303.

If the user is a non-celebrity member, or has not previously registered with the system, the user can be taken to a sign up page (not illustrated) where they can register to use the system. In one embodiment, the user may be required to provide information such as: a username, password, and other basic information necessary to establish a minimum site presence for the user.

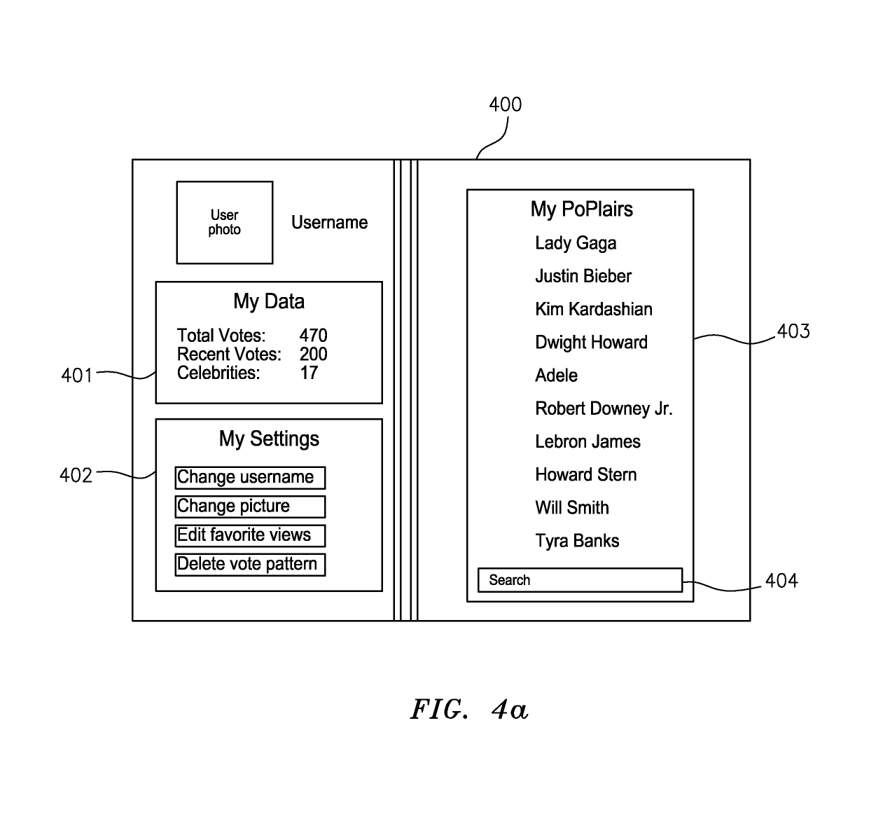

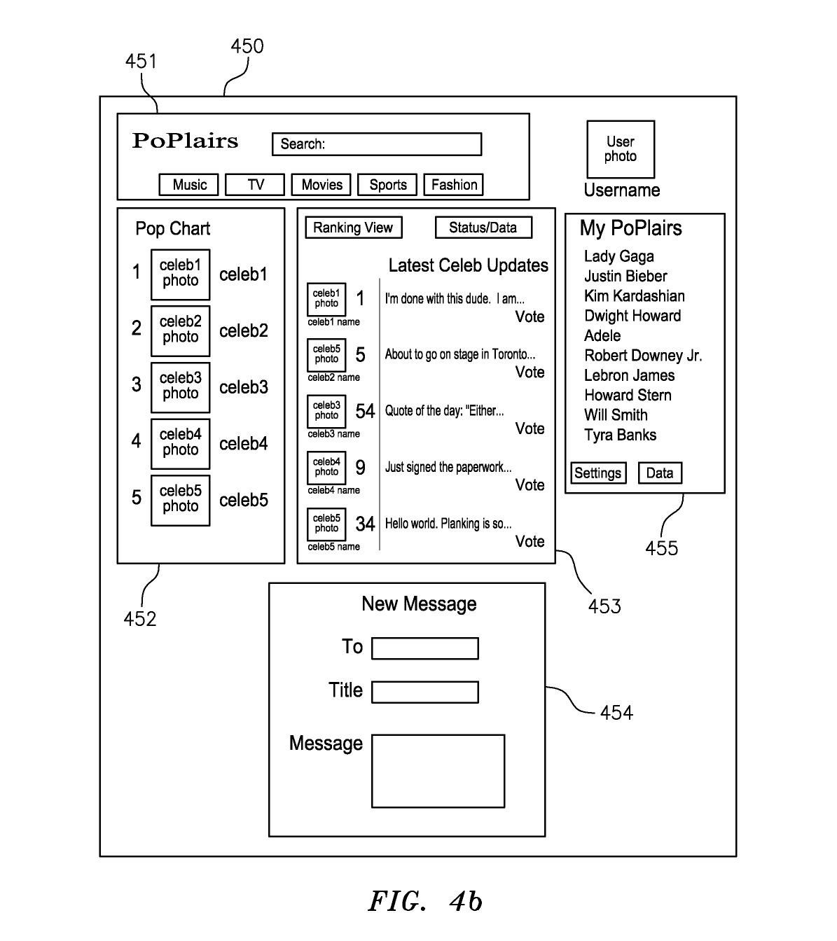

Upon registration, or logging in, the gatekeeper 120 can grant the non-celebrity member access to the database 135 in order to view celebrity pages. The gatekeeper can also direct the user to their welcome page in order to customize their settings. To this end, FIG. 4a illustrates one non-limiting example of a user welcome/profile page 400 for allowing the user to manage their site presence. As shown, page 400 can display a users avatar, the voting history of that user 401, allow the user to change their personal settings 402, display a list of their favorite celebrities (My PoPlairs) 403, and search 404 for additional celebrities/content within the social media system. Of course, the system can generate many additional options for the user to enjoy while utilizing the system.

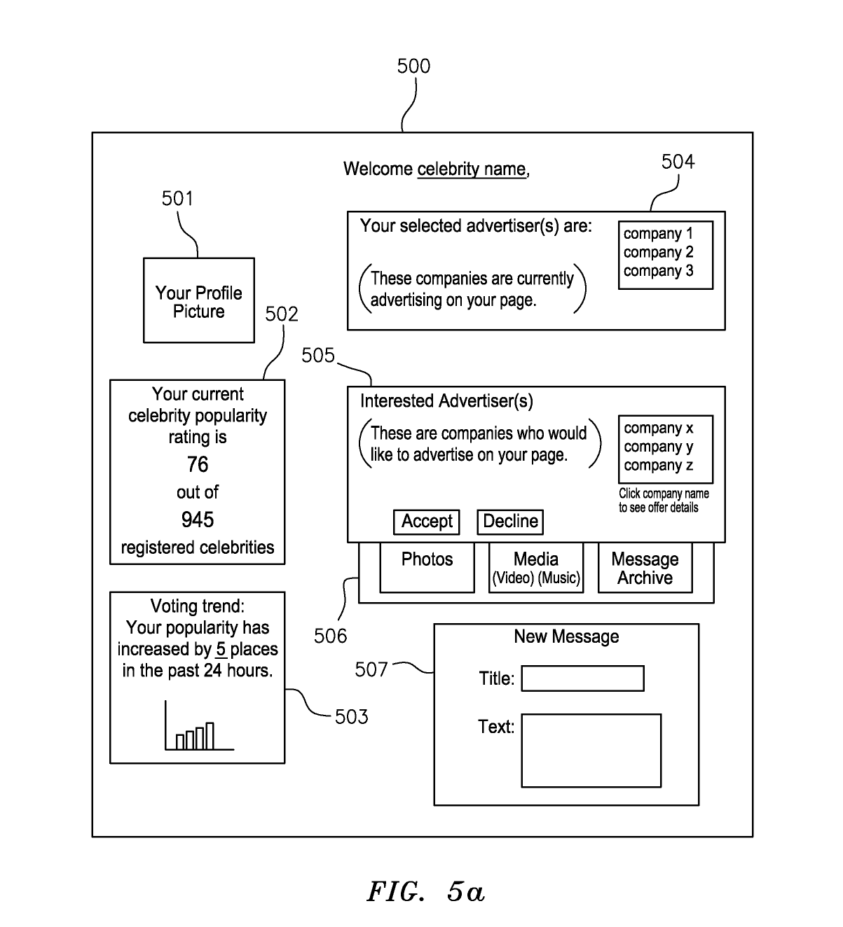

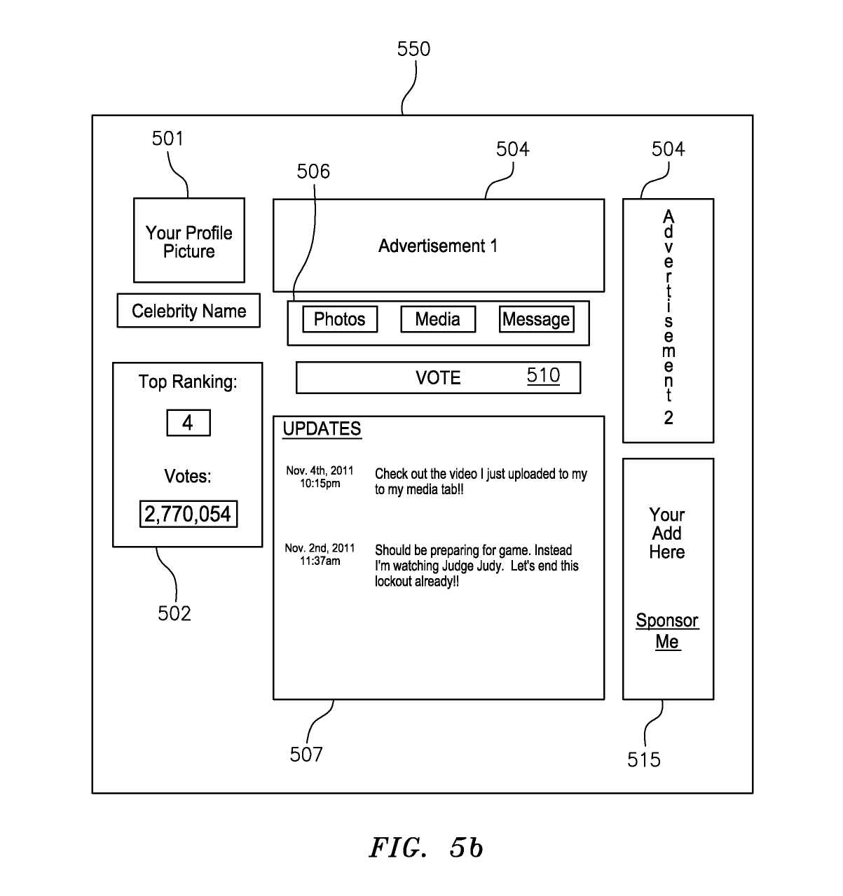

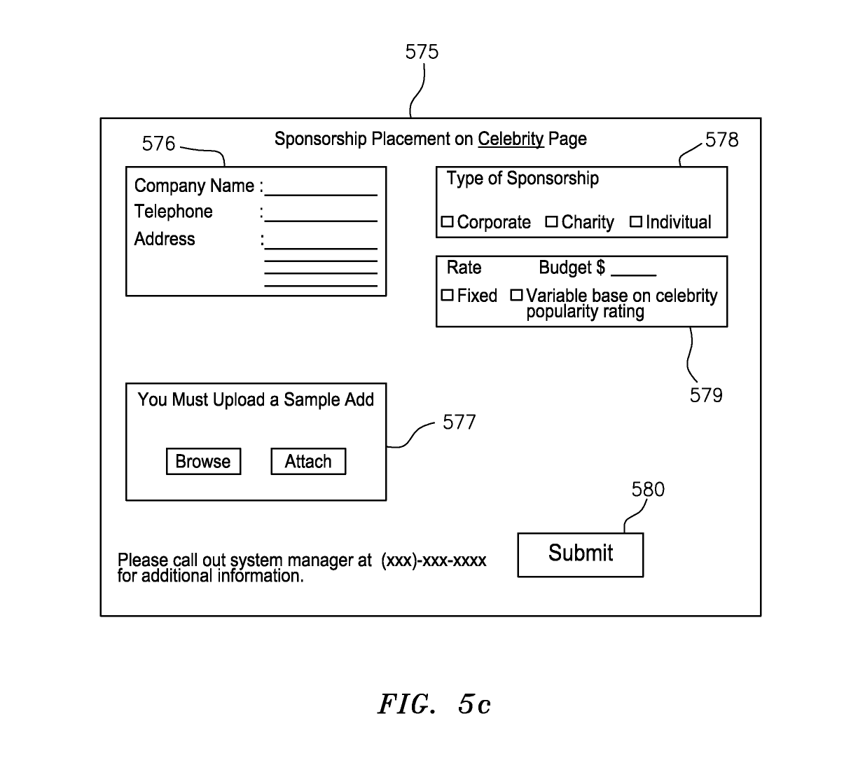

FIG. 4b illustrates one non-limiting embodiment of a user page 450 that is generated by the application system 130 based on the criteria specified in the users profile page 400. As shown, the user page 450 can include the ability to search for a list of celebrity members 451 to whom they wish to connect with in a social media setting. This search can be based on the name of the celebrity, or by categories such as music, TV, movies, sports, fashion and other such categories. The page can also display a list of the most popular celebrity members 452 based on the votes of all non-celebrity members. Next, the page can display the most recent updates from a plurality of celebrities 453, and can provide a message tab 454 for posting messages to the celebrity and/or other non-celebrity members. Finally, the page can include the list of the members favorite celebrities (My PoPlairs) 455 to whom the user has previously voted for. As will be described below, celebrity members can be added to a users My PoPlairs list by clicking “vote” on the celebrity's main page (See FIG. 5b below). Of course, other means for adding celebrities to a users My PoPlairs list are also contemplated.

Celebrities will be encouraged to utilize the social media system 100 as a primary means for communicating with their fans. In exchange for their participation, celebrities will be able to communicate with fans in a social media setting, while simultaneously receiving royalties (i.e. payments) from sponsors whose advertisements are displayed on the celebrity page(s). Each sponsor must be approved by the celebrity and the system management before the advertisement can begin. Such a feature can act to encourage greater celebrity involvement, as it eliminates the possibility of cross promotional/contractual issues with other companies, and by providing a financial incentive to the celebrity to communicate with fans often.

In one preferred embodiment, each celebrity member will be validated by a system administrator before a celebrity profile page can be created. As described herein, a system administrator can include a person who manually validates the identity of the celebrity before creating the profile page via the application system 130, or an automated system capable of authenticating a celebrities identity based on information provided by the celebrity (i.e. driver license number, social security number, and/or other personal information). Of course, any number of known systems/methods for verifying the identity of remotely located persons can also be utilized.

In either instance, once the celebrity's identity has been verified, the celebrity, or the system administrator can create a profile page for the celebrity. As such, by pre-validating the celebrities identity before a profile page can be created, non-celebrity members can be confident that they are actually communicating with the actual celebrity themselves, as opposed to imposters.

FIG. 5a illustrates one non-limiting example of a celebrity member profile page 500 for allowing a celebrity to manage their site presence. As shown, this page can allow the celebrity to post messages for their fans 507, change the main picture associated with their profile 501, and display the celebrities current popularity ranking 502. This ranking can be based on the total number of non-celebrity members who have voted to subscribe to a particular celebrity's page, as compared with the total number of celebrity members on the site. The page can also include a voting trend 503 capable of displaying real time popularity statistics and voting trends for the celebrity over a predetermined period of time. Additionally, options can be provided for allowing the celebrity to uploaded a host of media 506 such as pictures, video, music and the like.

In addition to the above, page 500 can also include a list of sponsors 504 who are currently advertising on the celebrities main page, and a list of potential sponsors 505 that have submitted offers or shown interest in advertising on the celebrity page.

As described herein, sponsors 504 can include individuals, companies and the like who have reached an agreement with the celebrity and site management to post content on the celebrities page in exchange for payment of royalties. To this end, the content can be subject to prior approval by the celebrity and site management, and royalties can include monetary payment, exchange of services or other valuable consideration. Potential sponsors 505 can include those who wish to become sponsors.

In one embodiment, a sponsorship agreement can be reached when a potential sponsor submits an offer to the celebrity via the “sponsor me” tab 515 on the celebrity page 550 described below.

FIG. 5b illustrates one non-limiting embodiment of a celebrity member main page 550 that is generated by the system 100 based on the criteria specified in the celebrities profile page 500. As shown, one or more of the sponsor advertisements 504 can be integrated within the content of the page in order to allow a seamless integration of celebrity content and advertiser material.

As further shown, page 550 can also include a vote button 510 for allowing non-celebrity members to subscribe to the celebrity page. To this end, when a site user clicks the vote button 510, the application system will link the celebrity page 550 to the users page 450, and the celebrity name will be added to the users My PoPlairs list. In one preferred embodiment, when a user votes for the celebrity, the user will receive information about the celebrity for a predetermined period of time, such as 90 days, for example. Throughout the course of this time, the user can cast additional votes (preferably no more than one vote per day for the same celebrity) in order to continue to receive the celebrity information, or the user can allow the vote to expire. Upon the expiration of the predetermined period of time, the application system will automatically remove the celebrity from the users My PoPlairs list and adjust the celebrities popularity rating to reflect the change.

In one alternate embodiment, the application system 130 can include programming for allowing celebrity pages to only display a portion of the celebrity content to site users until that user has voted for that celebrity. The amount of content can preferably be determined by the celebrity themselves, and can be called a “Tease Update”. To this end, upon first visiting a celebrity page, a user may not have access to additional messages, media and the like unless and until that user votes for that celebrity. Upon voting for the celebrity, the application system can then grant the user full or increased access to the celebrity page and information. Such a feature will act to encourage site users to vote for celebrities in order to get the exclusive content, while simultaneously providing accurate popularity ratings for the celebrity.

Such features can allow the system to maintain accurate celebrity popularity rankings based on the recent history/dealings of the celebrity, in order to ensure that only the most current and/or active celebrities are listed with high popularity rankings.

In one optional embodiment, the celebrity member page 550 can also include a “sponsor me” tab 515. As shown in FIG. 5c, when clicked, the application system can generate a sponsorship page 575 for a perspective sponsor to complete. Although there are a virtually unlimited number of options which can be included, several non-limiting options include the company name 576 advertising sample 577 (e.g., sample banners, pop up adds, video, and the like), type of sponsorship 578, rate and budget information 579 and a submit button 580. Upon submitting an offer, a system manager can review and approve the content and pricing information before making the offer available to the celebrity via the potential sponsor tab 505 on their member page 550. Alternatively, an interested sponsor can contact the system management directly in order to provide the information.

In another embodiment, the application system 130 can include programming for generating specific advertising rates based on the current popularity rating of a celebrity member. For example, a celebrity may require a base fee for all advertisements, and upon reaching a predetermined popularity ranking, an additional percentage can be added to the base fee. In either instance, the advertisements can be displayed in any number of manners such as: fixed place, rotating with other advertisers, or time based, to name a few.

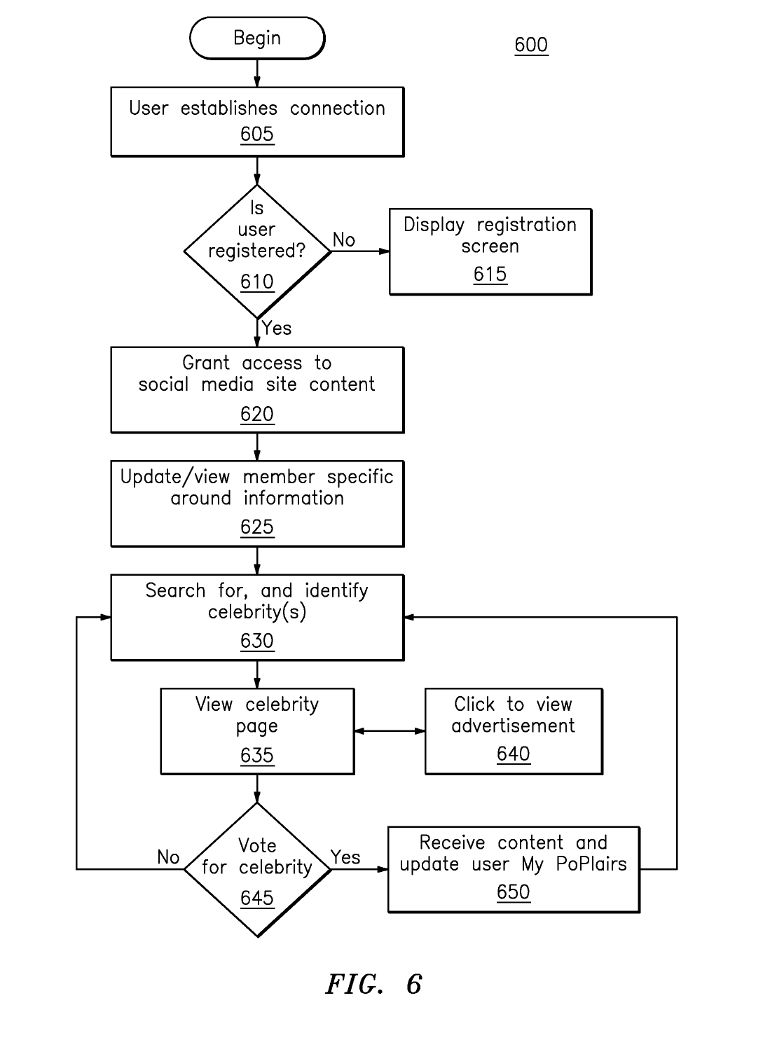

FIG. 6 illustrates a flow diagram 600 of a method for allowing a non-celebrity member to communicate with, and vote for their favorite celebrities in a social media setting utilizing the system 100 described above, in accordance with one embodiment of the present invention. Accordingly, at step 605 a user can activate an interface device 101 or 102 to establish communication with the interface gatekeeper 120 via the internet by selecting the URL for the social media site generated by the application system 130.

In step 610 the application system can prompt the user to identify themselves as a registered user by entering their assigned username and password. If the information submitted is correct, the registered user is provided access to the database 135 in step 620. If the user does not have a username or password, then they can be directed to the registration portal in step 615 where the user can provide basic information in order to allow the application system to create a user profile page. Upon successful registration, the user will then be granted access to use the social media site in step 620.

In step 625, the registered user can update their profile with additional personal information. In step 630, the user can search the database for their favorite celebrity members to whom they would like to connect with in a social media setting, and in step 635, the user can click on the identified celebrity page.

Upon viewing the celebrity page, the user can click on sponsored advertisements in step 640, or can cast a vote for the celebrity in step 645. If the user votes for the celebrity, they will be granted access to exclusive content from the celebrity, and their My PoPlairs will be updated to reflect the addition of the celebrity. If the user chooses not to vote for the celebrity, they can return to step 630.

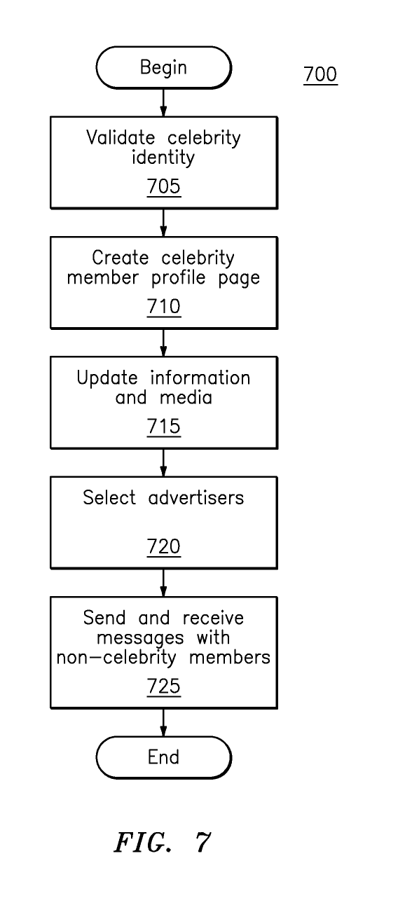

FIG. 7 illustrates a flow diagram 700 of a method for allowing a celebrity member to communicate with non-celebrity members, and to receive compensation from sponsors who advertise on the celebrity page, in accordance with one embodiment of the present invention.

Accordingly, at step 705 a system administrator can validate the identity of the celebrity who is interested in joining the site. Upon validation of the celebrity identity, a celebrity profile page can be created in step 710.

In step 715, the celebrity member can upload information such as pictures, and other such media for their fans to view. In step 720, the celebrity member can specify the sponsors who are permitted to advertise on their main page, receive royalties from the selected sponsors, and review offers from a list of potential sponsors.

In step 725, the celebrity members can send and receive messages with their fans in order to stay current in the popularity rankings and to encourage fans to click onto the sponsor adds located on the celebrity main page.

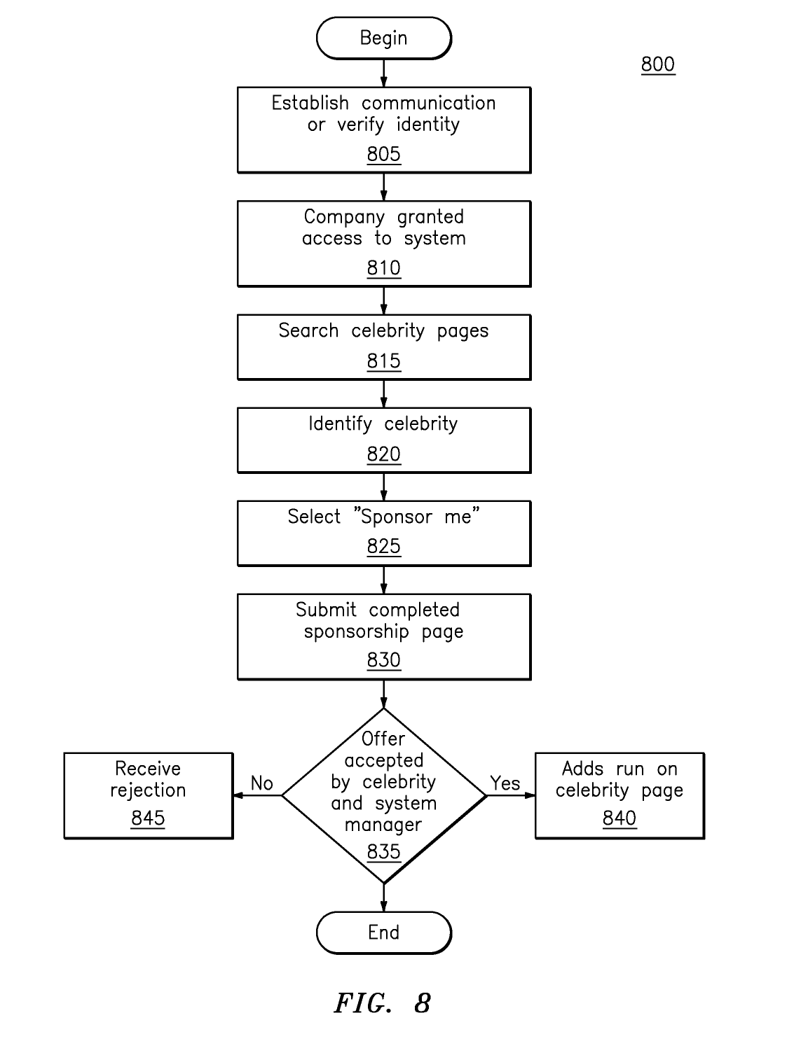

FIG. 8 illustrates a flow diagram 800 of a method for advertising on a celebrity page utilizing the system 100 in accordance with one embodiment of the present invention.

Accordingly, at step 805 a potential sponsor can either register to use the system (see steps 605-165 above) or a system administrator can validate the identity of the potential sponsor and grant access to the system (see steps 705-715 above), upon registration/validation, the potential sponsor will be granted access to the database in step 810.

In step 815 the potential sponsor can search the database to identify celebrity users they would like to advertise with. In step 820 the potential sponsor can view the celebrity page to whom they wish to advertise with.

In step 825, the potential sponsor can click the “sponsor me” tab and complete the required information, then submit the completed form in step 830. Upon approval by the system manager, the offer will be sent to the celebrity's list of “potential sponsors”.

In step 835, a decision will be made by the system manager and celebrity regarding the sponsorship offer. If the offer is accepted, the sponsor ads will be displayed on the celebrity page in step 840. If the offer is not accepted, a rejection notice will be sent to the potential sponsor in step 845.

Aspects are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method embodied on a computer readable for allowing a non-celebrity member to communicate with, and vote for a celebrity member within a social media web site, the method comprising:
establishing communication between the non-celebrity member and an application system hosting a social media website;
granting access to a database containing member pages of the social media website and celebrity popularity ratings;
generating a member page for the non-celebrity;
receiving commands from the non-celebrity member, via an input/output device to identify celebrity members of the social media website;
generating a first celebrity member page having limited content, celebrity approved advertisements, and a vote button based on the identification, said first celebrity page further including a current celebrity popularity rating for the identified celebrity;
receiving a vote command from the non-celebrity member;
registering the vote with the database to update the celebrity popularity rating;
generating a second celebrity member page having full celebrity content, celebrity approved advertisements, and a direct communication pathway between the celebrity member and the non-celebrity member; and
linking the second celebrity member page to the non-celebrity member page.

2. The method of claim 1, wherein a celebrity popularity rating is determined based upon a total number of votes by non-celebrity members compared to other celebrity members.

3. The method of claim 1, wherein said vote includes an expiration date, and upon determining that the vote has expired:
removing the vote from the database and updating the celebrity rating,
revoking access by the non-celebrity member to the second celebrity member page, and
removing the link to the celebrity member page.

4. The method of claim 3, wherein a user can revote for a celebrity member, said revote being configured to restart the expiration date of the original vote.

5. A method embodied on a computer readable for allowing a celebrity member to create and maintain a social media page having celebrity approved advertisements thereon, the method comprising:
establishing communication between the celebrity member and an application system hosting a social media website;
validating, via a system administrator, an identity of the celebrity;
generating a celebrity popularity rating for the celebrity;
generating a celebrity access page, said page being configured to receive content from the celebrity;
generating a list of current and potential sponsors and displaying the same on the celebrity access page;
displaying a list of potential sponsor offers upon receiving a command from the celebrity;
accepting one or more of the potential sponsor offers upon receiving a command from the celebrity and updating the current sponsor list;
declining one or more of the potential sponsor offers upon receiving a command from the celebrity;
generating a first celebrity member page configured to be accessed by non-celebrity members, said page including limited celebrity provided content, a vote button and advertisements from a current sponsor;
determining that a non-celebrity user has selected an advertisement;
displaying the advertisement to the non-celebrity user; and
compensating the celebrity for the selected advertisement.

6. The method of claim 5, further comprising:
receiving a vote command from the non-celebrity member;
updating the celebrity popularity rating; and
generating a second celebrity member page configured to be accessed by non-celebrity members who have an active vote for the celebrity, said second member page including all celebrity provided content, a direct communication pathway between the celebrity member and the non-celebrity member, and at least one advertisement from a current sponsor.

7. The method of claim 6, further comprising:
generating a “sponsor me” button on at least one of the first and second celebrity member pages, said button being configured to allow a user to provide sponsorship offers to the celebrity.

8. The method of claim 7, further comprising:
updating the list of potential sponsors to include the sponsorship offer.

9. A method embodied on a computer readable for allowing a potential sponsor to advertise on a celebrity member page on a social media site, the method comprising:
establishing communication between a potential sponsor and a system administrator;
validating, via the system administrator, an identity of the potential sponsor;
granting access to a database containing member pages of the social media website and celebrity popularity ratings;
receiving commands from the potential sponsor, via an input/output device to identify celebrity members of the social media website;
generating celebrity member pages having limited content, celebrity approved advertisements and a sponsorship button;
generating a sponsorship page upon determining that the sponsorship button has been accessed;
receiving sponsorship information from the potential sponsor;
listing the sponsorship information from the potential sponsor on a celebrity access page;
determining acceptance of the sponsorship by the celebrity; and
displaying an advertisement from the potential sponsor on the celebrity main page.

10. The method of claim 9, further comprising:
Generating a sponsorship rate based upon the popularity rating of the celebrity.

11. The method of claim 10, further comprising:
displaying the generated sponsorship rate on the sponsorship page.
